(19) United States
(12) Patent Application Publication
(10) Pub. No.: US 2011/0122836 A1
(43) Pub. Date: May 26, 2011

(54) Apparatus and method for providing service in communication system

(75) Inventor: Jai-Dong Kim, Yongin-si (KR)

(73) Assignee: SAMSUNG ELECTRONICS CO., LTD., Suwon-si (KR)

(21) Appl. No.: 12/927,734

(22) Filed: Nov. 23, 2010

(30) Foreign Application Priority Data
Nov. 24, 2009 (KR) 10-2009-0113856

(51) Int. Cl. H04W 72/04

(52) U.S. Cl. 370/329

(57) ABSTRACT

In a communication system, UE (User Equipment) concurrently provides a plurality of services based on priority. Currently available resources of the UE are confirmed when the UE is required to provide a service that is different from a plurality of services that are currently being provided. Connection of corresponding services are cancelled iteratively, starting from a service with the lowest user preference, until the currently available resources become sufficient to provide the required service if the currently available resources are not sufficient to provide the required service. The priority can be based on user preferences that are managed for a plurality of services that can be provided in the UE.

### CROSS-REFERENCE TO RELATED APPLICATION(S) AND CLAIM OF PRIORITY

The present application is related to and claims the priority under 35 U.S.C. §119(a) of an application entitled “Apparatus And Method For Providing Service In Communication System” filed in the Korean Industrial Property Office on Nov. 24, 2009 and assigned Serial No. 10-2009-0113856, the contents of which are hereby incorporated by reference.

### TECHNICAL FIELD OF THE INVENTION

The present invention relates to a communication system and, more particularly, to an apparatus and method for providing a service in consideration of a user preference.

### BACKGROUND OF THE INVENTION

In the next-generation communication system, due to an epoch-making development of mobile communication and the expansion of communication networks, more expandable and diverse services and applications using UE (User Equipment) are in demand. However, resources that may be used to concurrently provide such services and applications in the UE are limited. Accordingly, in the related art, there is a problem in that it may be impossible to provide all services and applications demanded by a user using the limited resources of the UE.

### SUMMARY OF THE INVENTION

To address the above-discussed deficiencies of the prior art, it is a primary object to provide an apparatus and method for concurrently providing a plurality of services in consideration of a user preference in a communication system.

In accordance with an aspect of the present invention, there is provided a UE (User Equipment) device providing a service in a communication system. The UE device includes an application unit that includes a control block that confirms currently available resources of the UE when the UE is required to provide a service that is different from a plurality of services that are currently being provided, and cancels connection of corresponding services iteratively, starting from a service with the lowest user preference, until the currently available resources become sufficient to provide the required service if the currently available resources are not sufficient to provide the required service. The UE device may also include a wireless protocol stack unit that includes a resource management block which manages user preferences for a plurality of services that may be provided in the UE.

In accordance with another aspect of the present invention, there is provided a method of providing a service through a UE (User Equipment) in a communication system. The method includes confirming currently available resources of the UE when the UE is required to provide a service that is different from a plurality of services that are currently being provided. Connections of corresponding services are canceled, starting from a service with the lowest user preference, until the currently available resources become sufficient to provide the required service if the currently available resources are not sufficient to provide the required service. The priority may be based on user preferences that are managed for a plurality of services that may be provided in the UE.

According to the present invention, all services and applications required by a user may be efficiently provided using limited resources of the UE by deleting a dedicated bearer of the service with the lowest preference among the currently provided services and connecting a dedicated bearer of another required service when providing of the other service is required while the UE provides the services.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a procedure of processing a voice call using VoLGA technology in a PS service based communication system according to an embodiment of the present invention;

FIG. 2 illustrates an example of a UI (User Interface) of a UE used in a PS service based communication system according to an embodiment of the present invention; and

FIG. 3 illustrates an example of a UE configuration unit for implementing the UI of FIG. 2 according to an embodiment of the present invention.

### DETAILED DESCRIPTION OF THE INVENTION

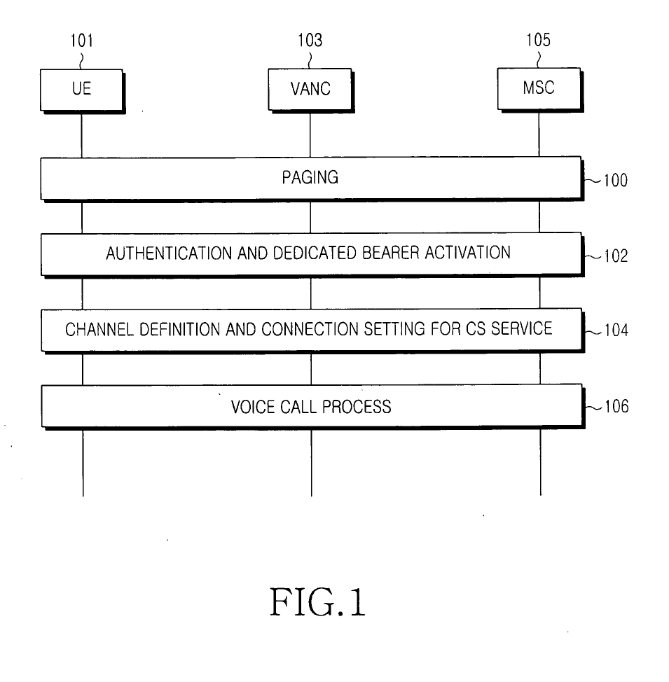

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication device. In the following description of the present invention, only portions required to understand the operation of the present invention will be described, and a detailed description of known functions and configurations incorporated herein will be omitted when it may make the subject matter of the present invention rather unclear.

In the following description of the present invention, schemes for concurrently providing a plurality of services in consideration of user preferences in a communication system will be described in detail.

LTE (Long Term Evolution) standardized by 3GPP (3rd Generation Partnership Project) and WiMAX (Worldwide Interoperability for Microwave Access) performed by IEEE (Institute of Electrical and Electronics Engineers) 802.16 are all PS (Packet Switched) service based communication systems, which do not support CS (Circuit Switched) service based voice services. In order to support the voice services in such a PS service based communication system, it is essential to use an IMS (Internet protocol Multimedia Subsystem). However, the IMS is very expensive in configuring the initial system, and there is a great possibility that the LTE or WiMAX is commercialized before the IMS technology is stabilized. Accordingly, in order to support the voice services in the PS service based communication system, technologies, such as CS fallback, One Voice, VoLGA (Voice over LTE via Generic Access), and the like, have been used.

The CS fallback is a technology that interrupts a PS service and provides a CS service if a voice service, i.e. the CS service, is required while a dual mode UE (User Equipment), which supports both the PS service and the CS service, performs the PS service.

One Voice is a technology that defines base functions, such as VoIP (Voice over Internet Protocol), SMS (Short Message Service), and the like, among the protocols of the IMS as profiles and provides the IMS service to suit the LTE commercialization schedule.

VoLGA is a technology that is provided by expendably applying a GAN (Generic Access Network) technology which is mainly used in Europe to the LTE, and transmits/receives CS based signaling with a PS based IP (Internet Protocol).

FIG. 1 illustrates a procedure of processing a voice call using VoLGA technology in a PS service based communication system according to an embodiment of the present invention.

Referring to FIG. 1, the communication system includes a UE 101, a VANC (Voice-Access Network Control) 103, and an MSC (Mobile Switching Center) 105.

The MSC 105 performs a paging procedure with the UE 101 through the VANC 103 (block 100), performs authentication of the UE 101, and activates a dedicated bearer (block 102). The MSC 105 defines a channel for transmitting/receiving a voice service, and sets connection for a CS service (block 104). Accordingly, the UE 101 receives and processes a voice call from the MSC 105 through the VANC 103 (block 106).

The UE 101, which transmits/receives a PS service, sets connection for the CS service through blocks 100 to 104, and receives and processes the voice call in block 106.

Alternatively, the UE, which can support the PS service, may concurrently perform one or more PS service applications according to its capability. The UE may provide the corresponding PS service applications to a user by efficiently dividing a display screen.

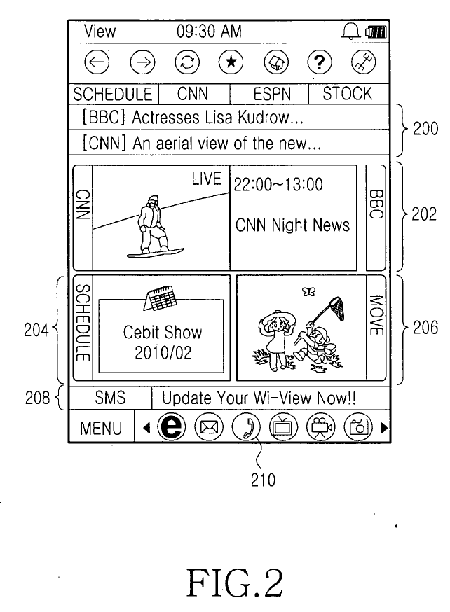

FIG. 2 illustrates an example of a UI (User Interface) of UE used in a PS service based communication system according to an embodiment of the present invention.

Referring to FIG. 2, the UI includes a news text service area 200 for displaying real-time headline news for each broadcasting company in the form of a text, a news image service area 202 for displaying a real-time news image of a broadcasting company (e.g. CNN) selected by a user, a schedule management service area 204 for user's schedule management, a VOD (Video On Demand) service area 206 for providing a VOD service, and an SMS service area 208 for transmitting/receiving an SMS in real time. In addition to the above-described areas, the UI further includes a voice call service icon 210 for transmitting/receiving a voice call service.

The UE has dedicated bearers that correspond in a one-to-one manner to the news text service area 200, the news image service area 202, the schedule management service area 204, and the VOD service area 206, respectively, and as an example, the dedicated bearers of the news text service area 200, the news image service area 202, the schedule management service area 204, and the VOD service area 206, being connected, are shown in FIG. 2. Different priorities are given to the services being provided through the respective areas in accordance with the user preferences. For example, the news text service may have priority 1 which is the highest priority, the news image service may have priority 2, the schedule management service may have priority 3, and the VOD service may have priority 4, which is the lowest priority.

If the execution of the voice call service is required through a user's clicking of the voice call service icon 210 or the reception of paging, the UE confirms the currently available resources (e.g. the entire bandwidth), and checks whether the currently available resources are sufficient to provide the voice call service. If the currently usable resources are sufficient to provide the voice call service, the UE immediately connects the dedicated bearer for the voice call service, and provides the voice call service to the user.

However, if the currently usable resources are not sufficient to provide the voice call service, the UE cancels the connection of the dedicated bearer of the service with the lowest priority among the corresponding services of the dedicated bearers being connected, i.e. in the order of their priority. In other words, the UE cancels the connection of the dedicated bearer of the corresponding service, starting from the service with the lowest priority, and connects the dedicated bearer of the voice call service until the currently usable resources become sufficient to provide the voice call service. Accordingly, the UE can provide the services desired by the user most efficiently using the resources according to the individual performance of the UE.

FIG. 2 illustrates, as an example, a situation in which the CS service such as the voice call service is required while the UE provides the PS service, such as the news text service, news image service, schedule management service, VOD service, and such. However, the scheme for providing the service required by the user in consideration of the priority according to the user preference as described above can be applied to any situation in which another service is required by the user while the UE receives the current service regardless of the kind of service.

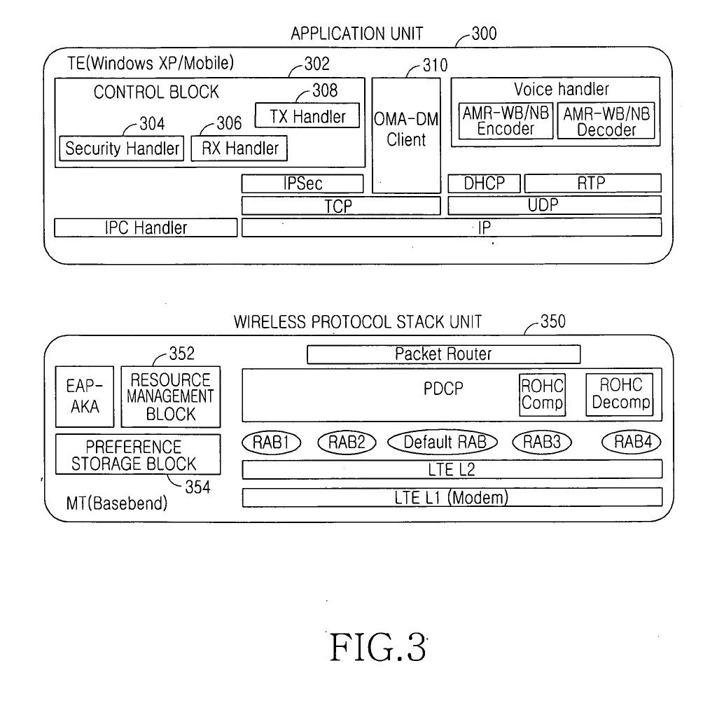

FIG. 3 illustrates an example of a UE configuration unit for implementing the UI of FIG. 2 according to an embodiment of the present invention.

Referring to FIG. 3, the UE includes an application unit 300 and a wireless protocol stack unit 350. The application unit 300 includes a control block 302 and an OMA-DM client (Open Mobile Aliance-Device Management client) 310, and the control block 302 includes a security handler 304, a reception handler (RX handler) 306, and a transmission handler (TX handler) 308. The wireless protocol stack unit 350 includes a resource management block 352 according to the system standard used, e.g. LTE or WiMAX, and a preference storage block 354.

The resource management block 352 detects a use frequency and use time of resources by bearers, a data rate measured when the corresponding resources by bearers are provided, a user billing system, and parameters remotely controlled by a service provider. Also, the resource management block 352 determines the preferences by services (i.e. bearers) based on at least one of detected information, and stores the determined preferences by services in the preference storage block 354.

The preference storage block 354 includes a memory region for storing the user preference by services. The user preference is initially set as a default value, but may be automatically updated according to the use frequency and use time of resources by bearers, the data rate measured when the corresponding resources by bearers are provided, and the a user billing system. It is also possible that the user preference is updated based on changes of preference for respective bearers remotely controlled by the service provider through a home page or an external device.

The control block 302, when providing another service is required by the user while the service is provided, inquires the user preferences for the currently provided services, which are stored in the preference storage block 354. Then, the control block 302 requests the deletion of the dedicated bearer of the service that corresponds to the lowest user preference, i.e. the service with the lowest priority, from a base station.

The OMA-DM client 310 is a protocol that makes it possible to change a parameter desired by the service provider through a remote access to the UE, and is used when it is intended to remotely control the user preference stored in the memory region of the preference storage block 354.

The control block 302, when providing another service is required while the service is provided to the user, checks whether the currently usable resources of the UE are sufficient to provide the required service.

If the currently usable resources of the UE are not sufficient to provide the required service, the control block 302 inquires the user preferences stored in the preference storage block 354, and requests the base station to delete the dedicated bearer of the service with the lowest preference among the currently provided services. The operation of requesting the deletion of the dedicated bearer of the service with the lowest priority is repeated until the currently usable resources become sufficient to provide the required service.

Through the above-described process, the base station deletes the requested dedicated bearer, and the control block 302 connects the dedicated bearer of another required service.

Hereinafter, the processes in which the providing of another service is required while the UE provides the service to the user will be described as an example.

An embodiment in which a voice call is terminated or received while the user executes an application in the form of audio/video such as IPTV (Internet Protocol Television), VOD, and such, in the UE will be described. The UE mutes the audio portion of the application being currently executed before a bell that reports the termination of the voice call rings. If the user refuses the voice call, the UE maintains the continuous operation of the application being executed by normally executing the audio portion.

However, if the user accepts the voice call, the UE interrupts the current session or stores a streaming signal that is received while the voice call is maintained in the memory when the streaming system of the currently executed application is a multicast UDP (User Datagram Protocol) system. Also, when the streaming system of the currently executed application is a unicast UDP system, the UE requests a server to interrupt the service by generating a new message or stores the streaming signal received during the maintenance of the voice call in the memory. Also, when the streaming system of the currently executed application is a unicast TCP (Transmission Control Protocol) system, the UE stores session information of the audio portion or stores the streaming signal received during the maintenance of the voice call in the memory.

If the user ends the voice call, the UE first reproduces an image that corresponds to the streaming signal stored in the memory, and then reproduces an image that corresponds to the received, streaming signal. Alternatively, if the streaming system of the currently executed application is a real-time streaming system, the UE first reproduces an image that corresponds to the streaming signal received in real time, and then determines whether to reproduce an image that corresponds to the streaming signal stored in the memory.

An embodiment in which a voice call is terminated or received while the user executes an application that is locally executed by an MP3 (MPEG Audio Layer 3) player and a movie player through the UE will be described. The UE makes the currently executed application pause before a bell that reports the termination of the voice call rings. If the user refuses the voice call, the UE maintains the continuous operation of the application being executed by normally executing the MP3 player or the movie player.

However, if the user accepts the voice call, the UE minimizes the power consumption through an operation such as turning off the MP3 player or a backlight of an LCD (Liquid Crystal Display) of the movie player. Alternatively, if a screen saver function of the LCD is locked at that time, the UE unlocks the screen saver function and then turns off the backlight of the LCD.

If the user ends the voice call, the UE performs the reproduction from the time point where the application is interrupted.

An embodiment in which an SMS is received while the user executes an arbitrary application in the UE will be described. The UE temporarily mutes the sound generated by the application in order to generate a bell sound for reporting the SMS. If the user selects the reproduction of the received SMS, the corresponding SMS is reproduced, and then the application being executed continues to be executed. However, if the user does not select the reproduction of the received SMS, the application being executed continues to be executed.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of providing a service through a UE (User Equipment) in a communication system, comprising:
confirming currently available resources of the UE when the UE is required to provide a service that is different from a plurality of services that are currently being provided; and
canceling connection of corresponding services iteratively, starting from a service with the lowest priority, until the currently available resources become sufficient to provide the required service if the currently available resources are not sufficient to provide the required service.

2. The method of claim 1, further comprising:
managing user preferences for the plurality of services that can be provided in the UE.

3. The method of claim 2, wherein canceling connection of the corresponding services iteratively, starting from the service with the lowest priority, comprises taking in consideration of the user preferences of the plurality of services.

4. The method as claimed in claim 1, further comprising connecting the required service if the currently available resources become sufficient to provide the required service after the connection of the corresponding service is canceled.

5. The method as claimed in claim 1, wherein the plurality of services correspond in a one-to-one manner to dedicated bearers, and wherein canceling the connection of the corresponding service comprises deleting a dedicated bearer of the corresponding service.

6. The method as claimed in claim 2, wherein each of the user preferences is determined based on at least one of a use frequency and use time of resources, a data rate measured when the corresponding resources are provided, a user billing system, and parameters remotely controlled by a service provider.

7. The method of claim 6, wherein the user preferences are stored by services.

8. The method of claim 5, wherein canceling the connection of the corresponding service further comprises requesting a base station for the deletion of the dedicated bearer of the corresponding service.

9. The method of claim 8, wherein if the required service is a voice call while the UE is currently executing an application that includes an audio service and video service, the audio service of the application is muted, and a streaming signal that is received while the voice call is maintained is stored in a memory until the voice call is terminated.

10. The method of claim 9, wherein when the voice call is terminated, the stored streaming signal received during the voice call is made available.

11. A UE (User Equipment) device providing a service in a communication system, comprising:
an application unit that comprises a control block configured to confirm currently available resources of the UE when the UE is required to provide a service that is different from a plurality of services that are currently being provided, and cancels connection of corresponding services iteratively, starting from a service with the lowest priority, until the currently available resources become sufficient to provide the required service if the currently available resources are not sufficient to provide the required service.

12. The UE device of claim 11, further comprising a wireless protocol stack unit comprising a resource management block which manages user preferences for the plurality of services that can be provided in the UE.

13. The UE device of claim 12, wherein the control block, when canceling connection of the corresponding services iteratively, starting from the service with the lowest priority, determines priority based on the user preferences of the plurality of services.

14. The UE device as claimed in claim 11, wherein the control block connects the required service if the currently available resources become sufficient to provide the required service after the connection of the corresponding service is canceled.

15. The UE device as claimed in claim 11, wherein the plurality of services correspond in a one-to-one manner to dedicated bearers, and the application unit cancels the connection of the corresponding service by deleting a dedicated bearer of the corresponding service.

16. The UE device as claimed in claim 12, wherein each of the user preferences is determined based on at least one of a use frequency and use time of the resources by services, a data rate measured when the corresponding resources by bearers are provided, a user billing system, and parameters remotely controlled by a service provider.

17. The UE device of claim 13, further comprising a memory configured to store the managed user preferences.

18. The UE device of claim 15, wherein the control block, when canceling the connection of the corresponding service, requests a base station to delete the dedicated bearer of the corresponding service.

19. The UE device of claim 18, wherein if the required service is a voice call while the application unit is currently executing an application that includes an audio service and video service, the control block mutes the audio service of the application, and stores a streaming signal that is received while the voice call is maintained in a memory until the voice call is terminated.

20. The UE device of claim 19, wherein when the voice call is terminated, the control block makes available the streaming signal that was stored during the voice call.
